(19) United States
(12) Patent Application Publication
(10) Pub. No.: US 2004/0092294 A1
(43) Pub. Date: May 13, 2004

(54) Method for performing a one-touch call operation using a wireless mobile terminal

(75) Inventor: Jeong-Kyu Moon, Suwon-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/646,153

(22) Filed: Aug. 21, 2003

(30) Foreign Application Priority Data
Nov. 11, 2002 (KR) P2002-69635
Jun. 4, 2003 (KR) P2002-36050

(51) Int. Cl. H04M 1/00; H04B 1/38

(52) U.S. Cl. 455/564; 455/550.1

(57) ABSTRACT

A method for easily transmitting a message and a phone number to a called mobile terminal through the use of a one-touch call button when the calling mobile terminal cannot establish a call connection with the called mobile terminal. Therefore, there is no need for a user to manually input a phone number and message to be transmitted. A message from the calling mobile terminal is transmitted to the called mobile terminal on condition that the calling and called mobile terminal are all connected to a network, thereby quickly performing a calling operation.

### PRIORITY

This application claims priority to an applications entitled “METHOD FOR PERFORMING ONE-TOUCH CALL OPERATION USING WIRELESS MOBILE TERMINAL”, filed in the Korean Intellectual Property Office on Nov. 11, 2002 and assigned Serial No. 2002-69635 and to an application with the same title filed in the Korean Intellectual Property Office on Jun. 4, 2003 and assigned Serial No. 2003-36050, the contents of which are hereby incorporated by reference.

### BACKGROUND OF THE INVENTION

1. Field of the Invention

The present invention relates generally to a wireless mobile terminal, and more particularly to a method for performing a one-touch call operation using a wireless mobile terminal, thereby enabling a user of a calling mobile terminal to easily leave a message in a message inbox of a called mobile terminal using a one-touch call button when the calling mobile terminal cannot connect with the called mobile terminal.

2. Description of the Related Art

Typically, when a call connection state between a mobile terminal of a user (i.e., a calling mobile terminal) and a mobile terminal of a called party (i.e., a called mobile terminal) is not established even though the calling mobile terminal attempts to connect with the called mobile terminal, the calling mobile terminal gains access to a message inbox. In other words, when the calling mobile terminal cannot connect with the called mobile terminal even though it attempts to, for example, when the called mobile terminal is already in a call connection state with another mobile terminal or is in a no-call connection area, the calling mobile terminal is connected to a message inbox of a called party. In this case, provided that a user of the calling mobile terminal leaves a voice message or phone number in the message inbox, the message inbox transmits the voice message or phone number to the called mobile terminal through the use of a SMS (Short Message Service) function.

Besides such message transmission using the message inbox, the user of the calling mobile terminal can transmit a short message (e.g., a text message) to the called mobile terminal using the SMS function. When using a caller ID (i.e., a caller's phone number) display service, a caller ID is displayed on the called mobile terminal even though the caller does not establish a call connection with the called mobile terminal, such that a called person can recognize whom the caller is. Also, the caller may reattempt a call connection with the called mobile terminal by again pressing a phone number of the called mobile terminal.

However, the above-described method for connecting a calling mobile terminal to a message inbox when a call cannot be connected is comprised of many sub-steps, such that it is inconvenient for a caller to leave a message (i.e., voice or text message) or phone number in the message inbox, and unnecessary charges are assessed to the caller because of such inconvenience. Also, in order to transmit a text message to the called mobile terminal using the SMS function after the calling mobile terminal fails to establish a call connection with the called mobile terminal, a user of the calling mobile terminal must manually press again a plurality of number keys corresponding to a phone number of the called mobile terminal on the mobile terminal, thereby resulting in greater inconvenience of use. Therefore, a need exists for more convenient wireless mobile services for mobile terminals.

### SUMMARY OF THE INVENTION

Accordingly, the present invention has been designed in view of the above and other problems, and it is an object of the present invention to provide a method for performing a one-touch call operation which enables a calling mobile terminal to more easily leave a message in a message inbox of a called mobile terminal through the use of a one-touch call button when the called mobile terminal does not answer a call connection request of the calling mobile terminal, thereby increasing a user's convenience, and which enables the calling mobile terminal to quickly transmit a short message (e.g., a text message) to the called mobile terminal when the one-touch call button is pressed after establishing a call connection state between the calling mobile terminal and the called mobile terminal.

In accordance with one aspect of the present invention, the above and other objects can be accomplished by a method for performing a one-touch call operation using a wireless mobile terminal, including the steps of: a) attempting to establish a call connection with a counterpart mobile terminal using a mobile terminal of a user; and b) if the call connection between the user's mobile terminal and the counterpart mobile terminal is not established, pressing a one-touch call button of the user's mobile terminal, and transmitting a phone number of the user's mobile terminal and a message of the user to the counterpart mobile terminal using a one-touch call processing.

Preferably, the step of enabling pressing the one-touch call button of the user's mobile terminal to call the counterpart mobile terminal, includes the steps of: reading out a phone number of the user's mobile terminal; and simultaneously transmitting the phone number of the user's mobile terminal and a prescribed message to the counterpart mobile terminal.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a conceptual diagram illustrating a network structure for establishing a call connection using a wireless mobile terminal according to the present invention;

FIG. 2 is a flow chart illustrating a procedure for performing a one-touch call operation according to the present invention;

FIG. 3 is a flow chart illustrating a procedure for setting up a one-touch calling operation according to the present invention; and

FIG. 4 is a flow chart illustrating operations of a wireless mobile terminal in a one-touch call operation according to the present invention.

### DETAILED DESCRIPTION OF THE PREFERRED EMBODIMENTS

Preferred embodiments of the present invention will be described in detail herein below with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

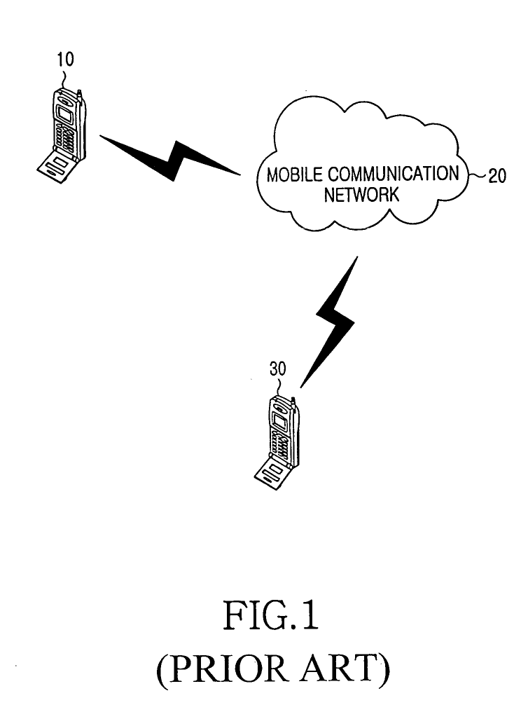

FIG. 1 is a conceptual diagram illustrating a network structure for establishing a one-touch call connection with a called party's mobile terminal using a wireless mobile terminal according to the present invention. Referring to FIG. 1, the network structure includes a mobile terminal 10, a mobile communication network 20, and a counterpart mobile terminal 30.

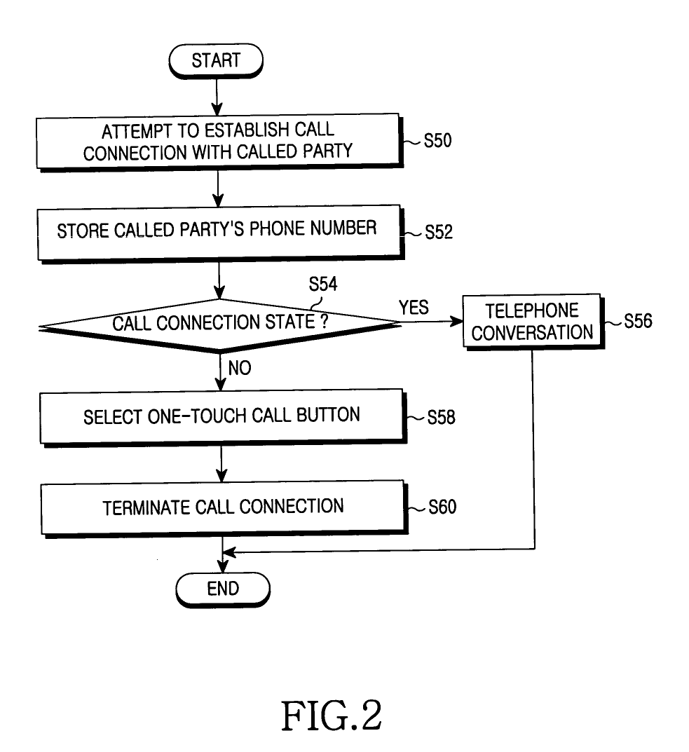

FIG. 2 is a flow chart illustrating a procedure for performing a one-touch call operation according to the present invention. Referring to FIG. 2, a user attempts to establish a call connection with a counterpart mobile terminal 30 using a mobile terminal 10 in step S50. Next, a phone number of the counterpart mobile terminal 30 is stored in a call list of the wireless mobile terminal 10 in step S52. When a call connection state between the mobile terminal 10 and the counterpart mobile terminal 30 is established in step S54, the user carries out a telephone conversation with a called party in step S56.

However, when a call connection state between the mobile terminal 10 and the counterpart mobile terminal 30 is not established in step S54, the call connection request from the mobile terminal 10 may enter a message inbox of the called party, or a user of the mobile terminal 10 may hear a busy tone or voice message indicating a busy state. In either one of the cases where the call connection request from the mobile terminal 10 enters the message inbox of the called party or the case where the user of the mobile terminal 10 hears the busy tone or voice message, a one-touch call button of the mobile terminal 10 is pressed in step S58, and a phone number and a short message of the user of the mobile terminal 10 are transmitted to the counterpart mobile terminal 30. The short message can be a previously recorded voice message or text message. The call connection is then terminated in step S60.

In this case, a SMS (Short Message Service) function is adapted to call the counterpart mobile terminal 30. If the mobile terminal 10 and the counterpart mobile terminal 30 are all connected to the mobile communication network 20, a message from the mobile terminal 10 is quickly transmitted to the counterpart mobile terminal 30.

Provided that the counterpart mobile terminal 30 is already in a call connection state with the mobile terminal 10, the message from the mobile terminal 10 is transmitted to the counterpart mobile terminal 30 at the fastest speed. In this case, the mobile terminal 10 and the counterpart mobile terminal 30 are all connected to a traffic channel such that the message from the mobile terminal 10 is transmitted to the counterpart mobile terminal 30 within one second.

When the counterpart mobile terminal 30 does not successfully receive such a message from the mobile terminal 10 even though a call connection state between the mobile terminal 10 and the counterpart mobile terminal 30 is established, the message is transmitted to the counterpart mobile terminal 30 over a paging channel within four or five seconds.

When the counterpart mobile terminal 30 is powered off or is in a no-call connection area, the message of the mobile terminal 10 is stored in a base station and then transmitted from the base station to the counterpart mobile terminal 30 when the counterpart mobile terminal 30 is powered on or enters a call service enabled area.

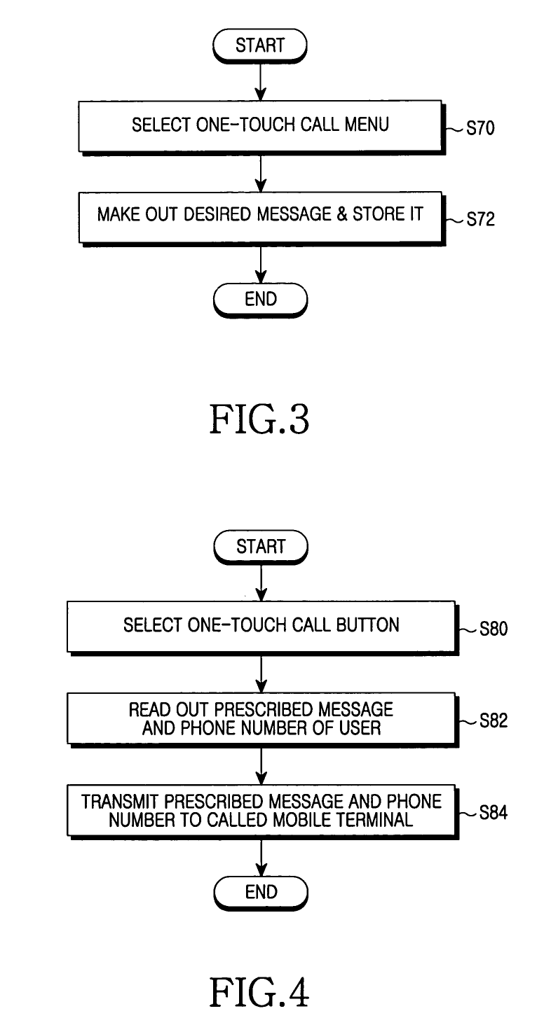

FIG. 3 is a flow chart illustrating a procedure for setting up a one-touch calling operation according to the present invention. Referring to FIG. 3, a user selects a one-touch call service menu on the mobile terminal 10 in step S70. The user can create a custom message using one of the many conventional text entering methods, and can store the created message in the mobile terminal 10 in step S72. If the user does not wish to create a message, the user can set a prescribed basic message (e.g., CALL ME BACK), which is transmitted to the counterpart mobile terminal 30 along with a phone number of the mobile terminal 10. Also, the user may previously determine a one-touch call button of the mobile terminal 10 to establish a one-touch call service in step S72. If the one-touch call button of the mobile terminal 10 is then pressed, the prescribed basic message is transmitted to the counterpart mobile terminal 30 along with the phone number of the mobile terminal 10.

Although a mobile terminal's interface for enabling a user to manually create a short message, and other interfaces for enabling the user to determine a one-touch call button may be implemented with a variety of graphic interfaces, their detailed description will herein omitted for the convenience of description and better understanding of the present invention, because this implementation method is well-known to the art.

As described above, an SMS message to be contained in a short message may be previously set in the mobile terminal 10, and a one-touch call button for performing such a one-touch call operation may also be previously set in the mobile terminal 10.

FIG. 4 is a flow chart illustrating operations of the wireless mobile terminal 10 in a one-touch call operation according to the present invention. In more detail, FIG. 4 is a flow chart illustrating operations performed when a user presses the one-touch call button in step S58 as illustrated in FIG. 2.

Referring to FIG. 4, when a call connection state between the mobile terminal 10 and the counterpart mobile terminal 30 is not established after the mobile terminal 10 transmits a call connection request to the counterpart mobile terminal 30, the call connection request from the mobile terminal 10 enters a message inbox of the called party, or a user of the mobile terminal 10 hears a busy tone or voice message indicating a busy state. In this case, the user of the mobile terminal 10 presses a one-touch call button on the mobile terminal 10 at step S80. When the one-touch call button is pressed in step S80, a phone number of the user's mobile terminal 10 and a prescribed message are read out from a memory of the mobile terminal 10 in step S82 and transmitted to the counterpart mobile terminal 30 in step S84. That is, the phone number and the prescribed message are transmitted to the counterpart mobile terminal 30 according to a one-touch call processing.

This method for carrying out the one-touch call operation according to the present invention enables a caller to easily leave a message in a message inbox of a called party through the use of a one-touch call button when a call connection state between the mobile terminal and the counterpart mobile terminal is not established.

Additionally, a message created by the caller mobile terminal is transmitted to the counterpart mobile terminal at the fastest transfer rate on condition that the caller mobile terminal 10 and the counterpart mobile terminal 30 are all connected to a traffic channel.

If a call connection state between the mobile terminal and the counterpart mobile terminal is not established after the mobile terminal transmits a call connection request signal to the counterpart mobile terminal, or if the counterpart mobile terminal is powered off or is in a no-call connection area, a short message of the mobile terminal is transmitted to a base station over a paging channel. Then, when the counterpart mobile is powered on or enters a call service enabled area, the base station transmits the received short message to the counterpart mobile terminal.

As is apparent from the above description, if a call connection state between the mobile terminal and the counterpart mobile terminal is not established and the user of the mobile terminal presses a one-touch call button, a prescribed basic message is transmitted to the counterpart mobile terminal along with the phone number of the mobile terminal.

If a user of the mobile terminal presses a one-touch call button when transmitting an SMS message to the counterpart mobile terminal, a phone number of the mobile terminal and a prescribed SMS message are transmitted to the counterpart mobile terminal.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for storing a message for use in a one-touch call operation using a mobile terminal, comprising the steps of:
selecting a one-touch call menu command of the mobile terminal;
determining a button to be used for the one-touch call operation;
entering a message to be transmitted to a counterpart mobile terminal when performing the one-touch call operation; and
storing the message.

2. The method of claim 1, wherein the message is a recorded voice message.

3. The method of claim 1, wherein the message is text message.

4. A method for performing a one-touch call operation using a mobile terminal, comprising the steps of:
attempting to establish a call connection with a counterpart mobile terminal using the mobile terminal; and
if the call connection between the mobile terminal and the counterpart mobile terminal is not established, pressing a one-touch call button of the mobile terminal, and transmitting a predetermined message to the counterpart mobile terminal using a one-touch call processing.

5. The method as set forth in claim 4, wherein the step pressing the one-touch call button of the mobile terminal, includes the steps of:
reading out a phone number of the mobile terminal and the predetermined message from a memory of the mobile terminal; and
simultaneously transmitting the phone number of the mobile terminal and the predetermined message to the counterpart mobile terminal.

6. The method of claim 4, wherein the predetermined message is a previously recorded voice message.

7. The method of claim 4, wherein the predetermined message is a previously entered text message.

8. A method for performing a one-touch call operation using a mobile terminal, comprising the steps of:
attempting to establish a call connection with a counterpart mobile terminal using the mobile terminal;
if the call connection between the mobile terminal and the counterpart mobile terminal is not established, pressing a one-touch call button of the mobile terminal for performing the one-touch call operation; and
transmitting a phone number of the mobile terminal and a predetermined message to the counterpart mobile terminal.

9. The method of claim 8, wherein the predetermined message is a previously recorded voice message.

10. The method of claim 8, wherein the predetermined message is a previously entered text message.
